(19) United States
(12) Patent Application Publication
(10) Pub. No.: US 2002/0108431 A1
(43) Pub. Date: Aug. 15, 2002

(54) Moisture sensor and associated process

(76) Inventor: Steven A. Hoffman, Sunnyvale, CA (US)

Correspondence Address: Kevin M. Kercher, Husch & Eppenberger, LLC, 401 Main Street, Suite 1400, Peoria, IL, 61602-1241, US

(21) Appl. No.: 09/843,410

(22) Filed: Apr. 26, 2001

Related U.S. Application Data
(60) Provisional application No. 60/267,390, filed on Feb. 9, 2001.

(51) Int. Cl. G01N 5/02; G01N 25/56

(52) U.S. Cl. 73/73; 116/206

(57) ABSTRACT

A moisture sensor is disclosed that includes a capsule, having a bottom portion and a top portion and an inlet for receiving fluid located at the top portion of the capsule, wherein the capsule is capable of containing at least one chemical that changes appearance in the fluid's presence. There is also a process for utilizing a moisture sensor that is disclosed. The process includes inserting at least one chemical that changes appearance when a fluid is present in a capsule, wherein the capsule has a bottom portion and a top portion and an inlet for receiving fluid located at the top portion of the capsule, and inserting the capsule into a ceiling where the bottom portion of the capsule is located below the ceiling. There can be a single chemical or substance that changes color in the presence of fluid or an upper layer and a lower layer of chemical where the upper layer goes from a solid to a liquid permeating the lower layer of chemical and changing overall appearance of the lower layer of chemical that is visible through the capsule as well as numerous chemical combinations.

### BACKGROUND OF THE INVENTION

Fluid leakage or flooding creates tremendous problems for property owners. If this activity is hidden for a long period of time, the amount of damage can be very costly. Sheet rock, plaster, wood and tile ceilings are used in most buildings and are astethically very pleasing to the eye. However, fluid can leak from the roof or pipe/conduit and lie on top of this ceiling. The fluid will then build-up until a major portion of the ceiling is completely destroyed with the fluid eventually breaking through to damage furnishings and other expensive equipment or personal property. Also, this fluid leaking from either the roof or a conduit, if left unchecked, can destroy other woodwork and cause structural damage to the building. This fluid, e.g., water, damage can lead to mold and insect infestation. The time period between when a fluid leak is detectable to a human observer and when the fluid leak is actual present can be a significant period of time that can result in tremendous property damage to the building.

The present invention is directed to overcoming one or more of the problems set forth above.

### BRIEF SUMMARY OF THE INVENTION

In one aspect of this invention, a moisture sensor is disclosed. The moisture sensor includes a capsule, having a bottom portion and a top portion and an inlet for receiving fluid located at the top portion of the capsule, wherein the capsule is capable of containing at least one chemical that changes appearance in the fluid's presence.

In another aspect of this invention, a process for utilizing a moisture sensor is disclosed. The process includes inserting at least one chemical that changes appearance when a fluid is present in a capsule, wherein the capsule has a bottom portion and a top portion and an inlet for receiving fluid located at the top portion of the capsule, and inserting the capsule into a ceiling where the bottom portion of the capsule is located below the ceiling.

### BRIEF DESCRIPTION OF THE DRAWINGS

For a better understanding of the present invention, reference may be made to the accompanying drawings in which:

FIG. 1 is a side elevational view of a moisture sensor of the present invention;

FIG. 2 is a perspective view of the bottom portion of the moisture sensor of the present invention mounted in a ceiling;

FIG. 3 is a top view of the moisture sensor of the present invention shown in FIG. 1, of the present invention; and

FIG. 4 is a side elevational view of a first alternative embodiment of the moisture sensor of the present invention utilizing a replaceable inner capsule.

### DETAILED DESCRIPTION OF THE INVENTION

In the following detailed description numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

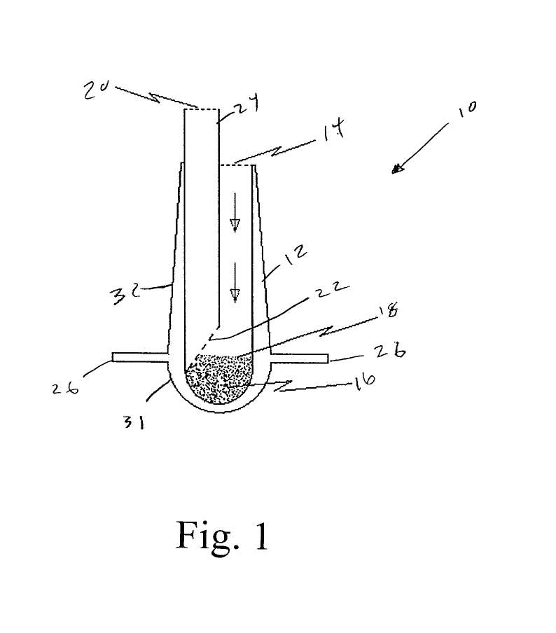

Referring now to the drawings, and initially to FIG. 1, which illustrates a moisture sensor that is generally indicated by numeral 10. The moisture sensor 10 includes a capsule 12 with a fluid inlet 14 where fluid, e.g. water, can enter the capsule 12. The capsule 12 includes both an enclosed bottom portion 31 and a top portion 32. The bottom portion 32 should be constructed out of either transparent or translucent material so that an appearance change, e.g., color change, of a substance located within the capsule can be visually detected outside of the capsule 12. The preferred structure of the capsule 12 is that of a cylinder, however, virtually any geometric shape will suffice. The preferred material is plastic, however, the material is not necessarily limited to this specific material. For example, other than the obvious drawback of breakage, glass would work as a material in this application. If utilizing plastic, the preferred process to create the capsule 12 is that of molding the plastic, however, any of a wide variety of plastic forming processes will suffice. If the plastic is molded, the preferred method is that of injection molding, however, any of a wide variety of molding processes will suffice, including stretch blow molding, among numerous other molding processes.

The capsule 12 holds or contains appearance-changing chemical(s) that sense the presence of a fluid in the capsule. There is a bottom chemical layer 16 that is typically neutral or white. Overlying the bottom chemical layer 16 is an upper chemical layer 18 that is typically a bright color. Although having the bottom chemical layer 16 a white or neutral color and the upper chemical layer 18 a bright color is preferred, all that is desirable is for there to be a noticeable appearance, e.g., color, contrast between the bottom chemical layer 16 and the upper chemical layer 18.

A nonlimiting preferred example, due to cost, is the utilization of common table salt in the bottom chemical layer 16 and food coloring, e.g., Red 40, in the upper chemical layer 18. The amounts can vary depending on the size of the capsule 12 and the amount of moisture desired before an indication is provided. When fluid seeps into the fluid inlet 14, the food coloring dissolves in the upper chemical layer 18 and seeps into the bottom chemical layer 16, which turns the bottom chemical layer 16, common table salt, a deep color representative of the food coloring, e.g. cherry red.

Another nonlimiting example would include the use of gelatin as the bottom chemical layer 16 and food coloring, e.g., Red 40, in the upper chemical layer 18. When this mixture of gelatin and food coloring is dry, it has a slight tinge of the color of the food coloring, e.g., pink. As in the previous example, when fluid seeps into the fluid inlet 14, the food coloring dissolves in the upper chemical layer 18 and seeps into the bottom chemical layer 16, which turns the bottom chemical layer 18 of gelatin into a deep color representative of the food coloring, e.g. cherry red. The preferred example of a gelatin is cherry flavored JELL-O®. JELL-O® is a registered trademark of Kraft Foods, Inc located at Three Lakes Drive, Northfield, Ill. 60093.

As described in the Federal Aviation Administration's Advisory Circular No. 20-125, dated Dec. 10, 1985, and initiated by AFS-340 regarding “Water in Aviation Fuels”, the presence of either a single chemical, e.g., paste or treated paper, which changes color in the presence of water is available. This approach, however, is more expensive than the common chemicals used in the preferred embodiment. Any of a wide variety of chemical combinations can also be utilized in this preferred embodiment.

In the preferred embodiment, there is a gas, e.g., air, exit tube 20 that allows trapped gas, e.g., air, to escape from the capsule 12. The gas exit tube 20 has an upper portion 24 that preferably extends outside the capsule 12 and a lower portion 22 that extends downward through the upper chemical layer 18 and into the bottom chemical layer 16. This slanted bottom portion 22 of the gas exit tube 20 allows gas to escape from inside the capsule 12 that is above the upper chemical layer 18, from the chemical in the upper chemical layer 18, and from the chemical in the bottom chemical layer 16.

There is a flange member 26 that is associated with a bottom portion of the capsule 12 for securing the moisture sensor 10 to a ceiling. This flange member 26 can be an integral portion of the capsule 12 or a separate component attached thereto. This flange member 26 can literally be any geometric shape or configuration with a preferred circular shape.

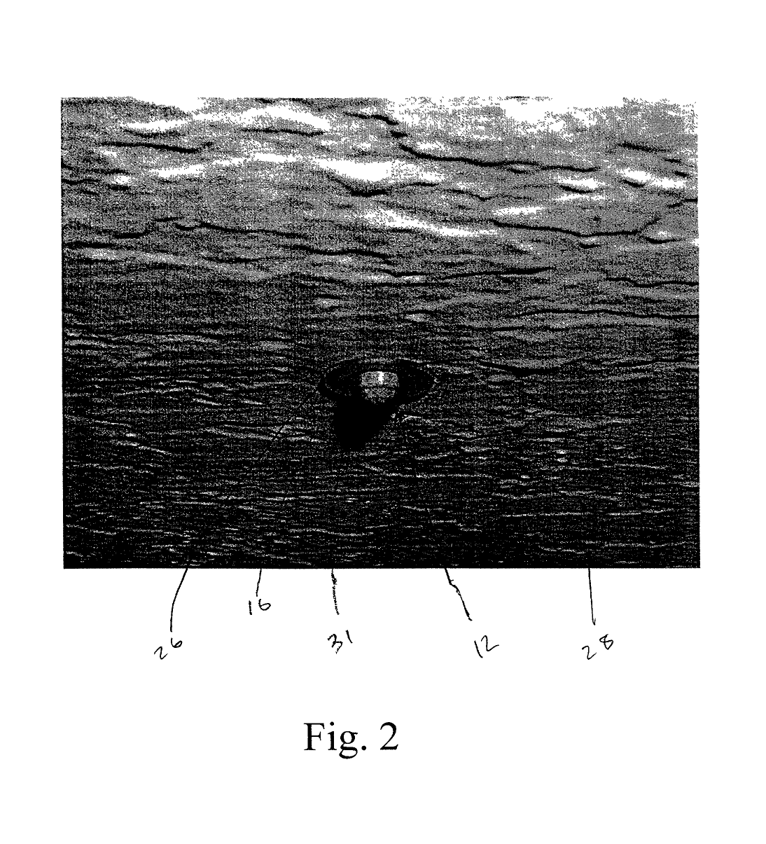

Referring now to FIG. 2, reveals the moisture sensor 10 mounted to a ceiling indicated by numeral 28. The ceiling 28, as illustrated, is sheet rock material, however, water damage can be a significant problem for plaster, tile and wood ceilings. These types of ceilings can conceal the presence of water above the ceiling 28 until significant damage is done to the ceiling 28 and other parts of the building. The flange member 26 fits against the ceiling 28 to visually reveal the bottom portion 31 of the capsule 12 containing the bottom chemical layer 16.

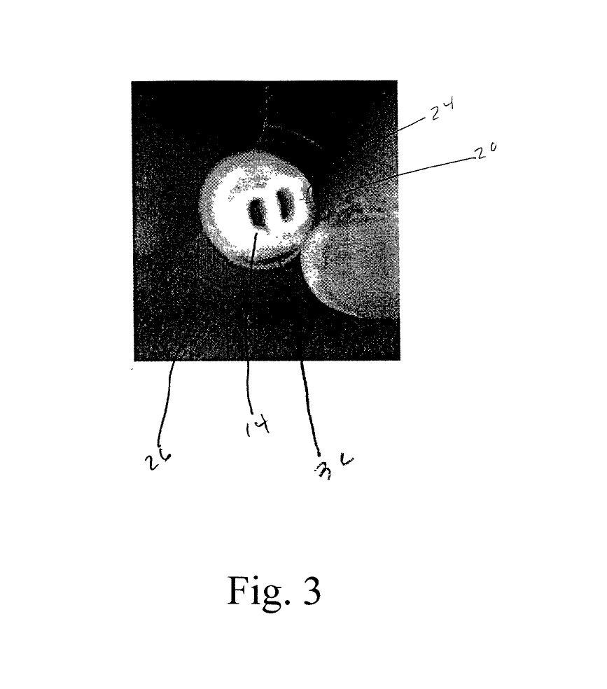

Referring now to FIG. 3, the upper portion 32 of the capsule 12 is shown that would be located at or above the ceiling 28. The fluid inlet 14 can collect fluid from a leak in the roof or from a fluid conduit/pipe. As previously described, this moisture passes into the capsule 12 and into the upper chemical layer 18, which typically but not necessarily, turns a chemical powder or solid into a fluid that seeps into the lower chemical layer 16. This changes the appearance, e.g., color, revealed by the lower portion 31 of the capsule 12 below the flange member 26 and the ceiling 28. This early detection can save expensive and costly repairs to the ceiling 28 and other parts of the building. The gas exit tube 20, for releasing gas, e.g., air, as previously described, has an upper portion 24 that preferably extends outside the capsule 12 is also shown in FIG. 3.

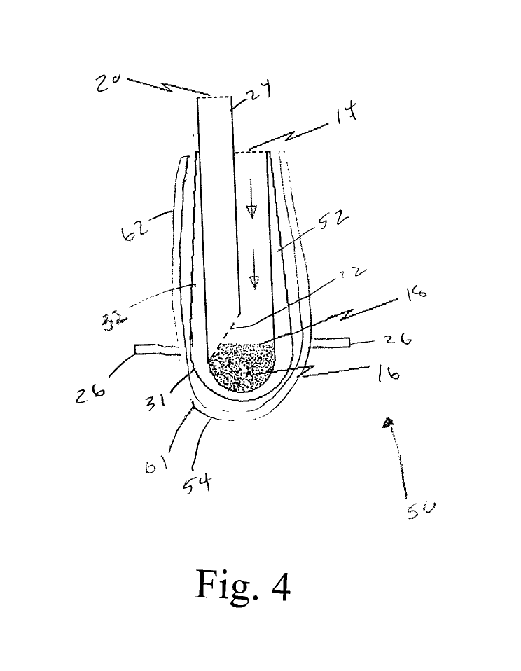

Referring now to FIG. 4, reveals an alternative embodiment of the present invention that is generally indicated by numeral 50. The difference between this embodiment and the preferred embodiment is that there is an inner capsule 52 that is replaceable within an outer capsule 54. The inner capsule 52 is almost identical in structure to capsule 12 of the previous embodiment, however, it is without a flange member 26.

The inner capsule 52 has a fluid inlet 14 where fluid, e.g. water, can enter the inner capsule 52. The inner capsule 52 includes both an enclosed bottom portion 31 and a top portion 32. The bottom portion 32 should be constructed out of either transparent or translucent material so that an appearance, e.g. color, change of a substance located within the capsule can be visually detected outside of the inner capsule 52. The preferred structure of the inner capsule 52 is that of a cylinder, however, virtually any geometric shape will suffice. The preferred material is plastic, however, the material is not necessarily limited to this specific material. For example, other than the obvious drawback of breakage, glass would work as a material in this application. If utilizing plastic, the preferred process to create the inner capsule 52 is that of molding the plastic, however, any of a wide variety of plastic forming processes will suffice. If the plastic is molded, the preferred method is that of injection molding, however, any of a wide variety of molding processes will suffice, including stretch blow molding, among numerous other molding processes.

The inner capsule 52 holds or contains color-changing chemical(s) that sense the presence of a fluid in the capsule. There is a bottom chemical layer 16 that is typically neutral or white. Overlying the bottom chemical layer 16 is an upper chemical layer 18 that is typically a bright color. Although having the bottom chemical layer 16 a white or neutral color and the upper chemical layer 18 a bright color is preferred, all that is desired is for there to be a noticeable color contrast between the bottom chemical layer 16 and the upper chemical layer 18.

A nonlimiting preferred example includes, due to cost, utilization of common table salt in the bottom chemical layer 16 and food coloring, e.g., Red 40, in the upper chemical layer 18. The amounts can vary depending on the size of the inner capsule 52 and the amount of moisture desired before an indication is provided. When fluid seeps into the fluid inlet 14, the food coloring dissolves in the upper chemical layer 18 and seeps into the bottom chemical layer 16, which turns the bottom chemical layer 16, of salt, a deep color representative of the food coloring, e.g. cherry red.

Another nonlimiting example would include the use of gelatin as the bottom chemical layer 16 and food coloring, e.g., Red 40, in the upper chemical layer 18. When this mixture of gelatin and food coloring is dry, it has a slight tinge of the color of the food coloring, e.g., pink. As in the previous example, when fluid seeps into the fluid inlet 14, the food coloring dissolves in the upper chemical layer 18 and seeps into the bottom chemical layer 16, which turns the bottom chemical layer of gelatin into a deep color representative of the food coloring, e.g. cherry red. The preferred example of a gelatin is cherry flavored JELL-O®. JELL-O® is a registered trademark of Kraft Foods, Inc located at Three Lakes Drive, Northfield, Ill. 60093.

As described in the Federal Aviation Administration's Advisory Circular No. 20-125, dated Dec. 10, 1985, and initiated by AFS-340 regarding “Water in Aviation Fuels”, the presence of either a single chemical, e.g., paste or treated paper, which changes color in the presence of water is available. This approach, however, is more expensive than the common chemicals used in the preferred embodiment. Any of a wide variety of chemical combinations can also be utilized in this alternative embodiment.

There is a gas, e.g., air, exit tube 20 that allows trapped air to escape from the inner capsule 52. The gas exit tube 20 has an upper portion 24 that preferably extends outside the inner capsule 52 and a lower portion 22 that extends downward through the upper chemical layer 18 and into the bottom chemical layer 16. This slanted bottom portion 22 of the gas exit tube 20 allows gas to escape from the inner capsule 52 that is above the upper chemical layer 18, from the chemical in the upper chemical layer 18, and from the chemical in the bottom chemical layer 16.

This inner capsule 52 is replaceably mounted within the outer capsule 54. The outer capsule 54 includes both a bottom portion 61 and a top portion 62. The bottom portion 61 should be constructed out of either transparent or translucent material so that an appearance change, e.g., color change, of a substance located within the outer capsule 54 can be visually detected outside of the outer capsule 54. The preferred structure of the outer capsule 54 is that of a cylinder, however, virtually any geometric shape will suffice. The preferred material is plastic, however, the material is not necessarily limited to this specific material. For example, other than the obvious drawback of breakage, glass would work as a material in this application. If utilizing plastic, the preferred process to create the outer capsule 54 is that of molding the plastic, however, any of a wide variety of plastic forming processes will suffice. If the plastic is molded, the preferred method is that of injection molding, however, any of a wide variety of molding processes will suffice, including stretch blow molding, among numerous other molding processes.

There is a flange member 26 that is associated with a bottom portion of the outer capsule 54 for securing the moisture sensor 50 to a ceiling. This flange member 26 can be an integral portion of the outer capsule 54 or a separate component attached thereto. This flange member 26 can literally be any geometric shape or configuration with a preferred circular shape.

Industrial Applicability:

The present invention is advantageously applicable in early detection of fluid leakage in ceilings, e.g. sheet rock, plaster, wood or tile ceilings. This can save thousands of dollars in building repair through the use of this moisture sensor 10.

The above advantages are only for the purposes of illustration and are not intended to limit the present invention as such. It will be recognizable, by those skilled in the art, that the present invention is suitable for a plurality of other applications.

In view of the foregoing, it is readily apparent that the subject moisture detector in a very simple and effective manner allows someone to detect fluid leakage in a building and prevent significant damage. Other aspects, objects and advantages of the present invention can be obtained from a study of the drawings, the disclosure and the appended claims.

What is claimed is:

1. A moisture sensor comprising:
a capsule, having a bottom portion and a top portion and an inlet for receiving fluid located at said top portion of said capsule, wherein said capsule is capable of containing at least one chemical that changes appearance in said fluid's presence.

2. The moisture sensor, as set forth in claim 1, further including a gas exit tube located within said capsule, wherein said gas exit tube includes an opening located at said top portion of said capsule.

3. The moisture sensor, as set forth in claim 1, wherein said fluid includes water.

4. The moisture sensor, as set forth in claim 1, wherein said capsule is cylindrical.

5. The moisture sensor, as set forth in claim 1, wherein said bottom portion of said capsule is transparent.

6. The moisture sensor, as set forth in claim 1, wherein said bottom portion of said capsule is translucent.

7. The moisture sensor, as set forth in claim 1, wherein said bottom portion of said capsule includes an outwardly extending flange member integral to said bottom portion of said capsule.

8. The moisture sensor, as set forth in claim 1, wherein said bottom portion of said capsule includes an outwardly extending flange member attached to said bottom portion of said capsule.

9. The moisture sensor, as set forth in claim 8, wherein said flange member is circular.

10. The moisture sensor, as set forth in claim 1, wherein said at least one chemical is a unitary chemical that changes color in a presence of water.

11. The moisture sensor, as set forth in claim 1, wherein said at least one chemical includes an upper chemical layer and a lower chemical layer.

12. The moisture sensor, as set forth in claim 11, wherein said upper chemical layer includes a food coloring and said lower chemical layer includes a salt.

13. The moisture sensor, as set forth in claim 11, wherein said upper chemical layer includes a food coloring and said lower chemical layer includes a gelatin.

14. The moisture sensor, as set forth in claim 1, further including an outer capsule, wherein said capsule is replaceably mounted within said outer capsule.

15. A process for utilizing a moisture sensor comprising:
inserting at least one chemical that changes appearance when a fluid is present in a capsule, wherein said capsule has a bottom portion and a top portion and an inlet for receiving fluid located at said top portion of said capsule; and
inserting said capsule into a ceiling where said bottom portion of said capsule is located below said ceiling.

16. The process for utilizing a moisture sensor according to claim 15, further including utilizing an exit tube located within said capsule, wherein said gas exit tube has an opening located at said top portion of said capsule for releasing gas from said at least one chemical that changes appearance when said fluid is present.

17. The process for utilizing a moisture sensor according to claim 15, wherein said capsule is cylindrical.

18. The process for utilizing a moisture sensor according to claim 15, wherein said bottom portion of said capsule includes an outwardly extending flange member.

19. The process for utilizing a moisture sensor according to claim 15, wherein said step of inserting at least one chemical that changes color when fluid is present in said capsule further includes utilizing an upper chemical layer and a lower chemical layer.

20. The process for utilizing a moisture sensor according to claim 19, wherein said upper chemical layer includes a food coloring and said lower chemical layer includes salt.

21. The process for utilizing a moisture sensor according to claim 19, wherein said upper chemical layer includes a food coloring and said lower chemical layer includes a gelatin.

22. The process for utilizing a moisture sensor according to claim 15, further including replaceably mounting said capsule within an outer capsule.
